(19) United States
(12) Patent Application Publication
(10) Pub. No.: US 2026/0120346 A1
(43) Pub. Date: Apr. 30, 2026

(54) Text-Driven Color Manipulation of Real Images

(71) Applicant: Google LLC, Mountain View, CA (US)

(72) Inventors: Kfir Aberman, San Mateo, CA (US); David Edward Jacobs, Mountain View, CA (US); Lucy Yu, Sunnyvale, CA (US)

(21) Appl. No.: 19/120,589

(22) PCT Filed: Oct. 12, 2022
(86) PCT No.: PCT/US2022/046427

§ 371 Date: Apr. 11, 2025

(51) Int. Cl. G06T 11/10; G06F 40/40; G06N 20/00; G06T 7/11

(52) U.S. Cl. CPC G06T 11/10; G06F 40/40; G06N 20/00; G06T 7/11; G06T 2207/10024; G06T 2207/20081; G06T 2207/20084

(57) ABSTRACT

Methods and techniques for manipulating the color of an image based on a text-based description are presented herein. A system can access an input image and an input text. The system can process, using a machine-learned recolorizing model, the input image to generate a recolorized image. A system can determine the similarity between the recolorized image and the input text description using a loss function and pre-trained encoder(s) which have been trained on a large dataset of text and images to convert the text and image inputs into the same embedding space. The system can then modify the one or more parameter values of the machine-learned recolorizing model to minimize the value of the loss function. Thus, after a plurality of iterations, the machine-learned recolorizing model will generate a recolorized photo that matches the description given in the input text.

### FIELD

The present disclosure relates generally to manipulating the color of real images. More particularly, the present disclosure relates to techniques for manipulating the color of real images that are driven by text.

### BACKGROUND

An individual may seek to manipulate the color of an image (e.g., photograph, frame of a video) for numerous reasons. These reasons include, for example, creative purposes, clarity reasons, or technical considerations. The combination of a machine-learning model and text-based descriptions of the desired outcome of the image manipulation can be used to generate a new image that reflects that description. However, existing approaches for manipulating images with text only work with synthetic images created by a pre-trained machine learning model. Such approaches only work on images containing subject matter similar to the subject matter on which the model was trained. Additionally, such existing approaches are limited in the resolution of the images they can generate due to the high-computational effort that is required. Consequently, there is a need for a text-driven approach to color manipulation that works with real, high-resolution images.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for recolorizing imagery based on text. The computer-implemented method can include accessing, by one or more computing devices, an input image and an input text. The computer-implemented method can further include, for each of a plurality of training iterations: using a machine-learned recolorizing model to process the input image and generate a recolorized image: generating a text embedding using the input text and a machine-learned text embedding model as well as generating one or more image embeddings using the recolorized image and a machine-learned image embedding model: evaluating an embedding loss function that compares the text embedding and the image embedding; and modifying one or more parameter values of the machine-learned recolorizing model based on the embedding loss. The computer-implemented method can further include, after the plurality of iterations, providing the recolorized image as an output image.

Another example aspect of the present disclosure is directed to a computing system. The computing system can include one or more processors and one or more tangible, non-transitory, computer readable media that store both a machine-learned recolorizing model and instructions, that when executed by the one or more processors, cause the computing system to perform operations. The machine-learned recolorizing model may be configured to generate a recolorized image using an input image and an input text. The operations may include, for a plurality of training iterations: accessing the input image and the input text: processing the input image using the machine-learned recolorizing model to generate the recolorized image: generating a text embedding using the input text and a machine-learned text embedding model as well as generating one or more image embeddings using the recolorized image and a machine-learned image embedding model: evaluating an embedding loss function that compares the text embedding and the image embedding; and modifying the one or more parameter values of the machine-learned recolorizing model based on the embedding loss. The operations may further comprise, after a plurality of iterations, providing the recolorized image as an output image.

Another example aspect of the present disclosure is directed to a memory which stores instructions. The instructions, when executed by a system comprising a processor, are configured to cause the system to access an input image and an input text. When executed, the instructions may further cause each of the following during a plurality of training iterations: the processing an input image with a machine-learned recolorizing model to generate a recolorized image: the generating of a text embedding using the input text and a machine-learned text embedding model as well as generating one or more image embeddings using the recolorized image and machine-learned image embedding model: the evaluating of an embedding loss function that compares the text embedding and the image embedding; and the modifying of one or more parameter values of the machine-learned recolorizing model based on the embedding loss. The instructions may further cause, after the plurality of iterations, the system to provide the recolorized image as an output image.

The technology described herein can be used to recolorize both real and synthetic images, high-resolution images, images containing diverse subject matter, as well as provide other improvements described herein.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system according to example embodiments of the present disclosure.

FIG. 1B depicts a block diagram of an example computing device according to example embodiments of the present disclosure.

FIG. 1C depicts a block diagram of an example computing device according to example embodiments of the present disclosure.

FIG. 2A depicts a flow diagram of an example technique for text-driven color manipulation according to example embodiments of the present disclosure.

FIG. 2B depicts a flow diagram of another example technique for the text-driven color manipulation according to example embodiments of the present disclosure.

FIG. 2C depicts a flow diagram of yet another example technique for the text-driven color manipulation according to example embodiments of the present disclosure.

FIG. 3 depicts a flow diagram of an example overall model according to example embodiments of the present disclosure.

FIG. 4 depicts a flow chart of an example method for the text-driven color manipulation of an image according to example embodiments of the present disclosure.

Reference numerals that are repeated across plural figures are intended to identify the same features in various implementations.

### DETAILED DESCRIPTION

### Overview

Generally, the present disclosure is directed to systems and methods for the text-driven color manipulation of images using machine-learned models. In some implementations, as described herein, an input image and an input text can be used to train a machine-learned recolorizing model to output a recolorized image. The recolorized image is a version of the input image that has been manipulated to better reflect the description included in the input text. As described herein, the present disclosure can be used to manipulate input images of varying domains (e.g., images with varying types of subject matter) and of varying resolutions (e.g., high-resolution, low-resolution). For example, different sections of the input image may be recolorized in different ways in order to better fit the description of the input text.

In particular, in some example implementations, the input image may have a plurality of channels including one or more chrominance channels and one or more luminance channels. Specifically, the machine-learned recoloring model may modify one or more values in the one or more chrominance channels while holding the one or more luminance channels fixed. The recolorized image will then be generated by combining the one or more modified values of the one or more chrominance channels with the values of the one or more luminance channels that were not modified.

According to another aspect of the present disclosure, certain portions of the techniques described herein can be performed on an image with a relatively lower resolution than the input image. As one example, in some implementations, the input image can be converted to a low-resolution version of the input image. Next, the low-resolution input image can be processed through a plurality of training iterations in which the machine-learned recolorizing model manipulates the low-resolution input image based on input text and the evaluation of the loss function. Because only color information is manipulated by the machine-learned recolorizing model, the resolution of the image being processed is of less important. After the loss between the text embedding and the one or more image embeddings has been sufficiently minimized, the machine-learned recolorizing model can then be applied to the high-resolution version of the input image. In such fashion, computational savings can be achieved by performing certain actions in lower resolution while maintaining the ability to achieve higher resolution, recolorized output images.

The systems and methods of the present disclosure provide several technical effects and benefits. Aspects of the present disclosure can provide several technical improvements to machine-learning training for image processing and editing, image processing technology, and image editing technology. As an example, techniques described in the present disclosure describe processes for converting texts and images into the same embedding space via a text-encoder and an image-encoder, respectively. The ability to compare the text and image embeddings allows for the manipulation of the input image according to the input text without the machine-learned recolorizing model being pre-trained on a set of images. Thus, the techniques described herein can be utilized to manipulate any type of image, rather than being limited to the set of images used to train the machine-learning recolorizing model or images with subject matter similar to that of the set of training images. Thus, the performed image editing can be applied to a much wider range of images, which represents an improvement in the technical ability of this image processing technology.

Additionally, to help improve the realism of a recolorized image, the image recolorization technology of the present disclosure can maintain the luminance values while manipulating the chrominance values of the image. Thus, in some implementations, only the minimum number of modifications needed to obtain the desired output image are made, which helps to preserve the realism in the output image. Thus, the performed image editing can be higher quality (e.g., more accurate) than previous techniques, which represents an improvement in the performance of a computing system.

Systems and methods described herein can also reduce the computing resources needed to perform the image processing. The techniques described in the present disclosure describe processes for transforming high-resolution images to low-resolution images in order to process the low-resolution images without losing the image quality of the final images that have been manipulated. By allowing the machine-learned recolorizing model to be trained on low-resolution images, the processing time is reduced and the computing resources required for the processing is reduced. As a result, the system can achieve state-of-the-art performance while maintaining a high level of image quality.

Moreover, using the techniques described herein, the system can demonstrate better performance over existing methods using internal real-world image data. The proposed approaches can manipulate the colors of one or more regions within an image, while maintaining the realism of the image, in less processing time and less computing resources than existing methods. This, in turn, improves the functioning of cameras, image recording devices, video recording devices, image processing devices, and other image-related devices.

With reference now to the Figures, example embodiments of the present disclosure will be discussed in further detail.

### Example Devices and Systems

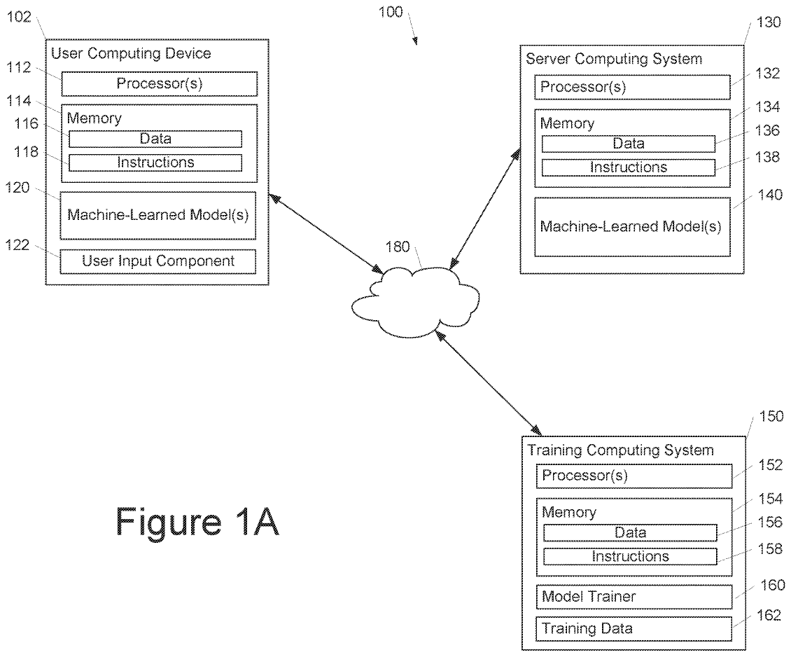

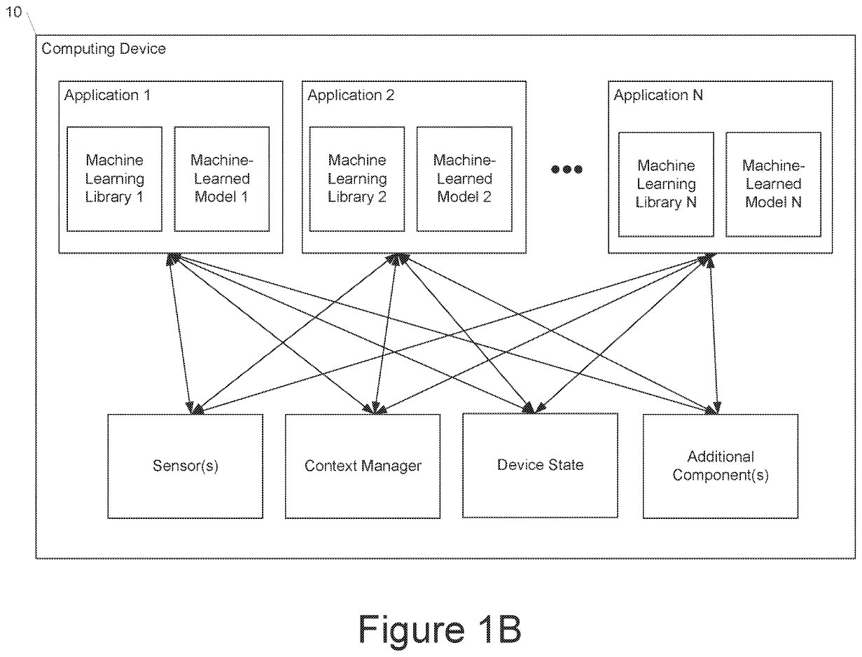

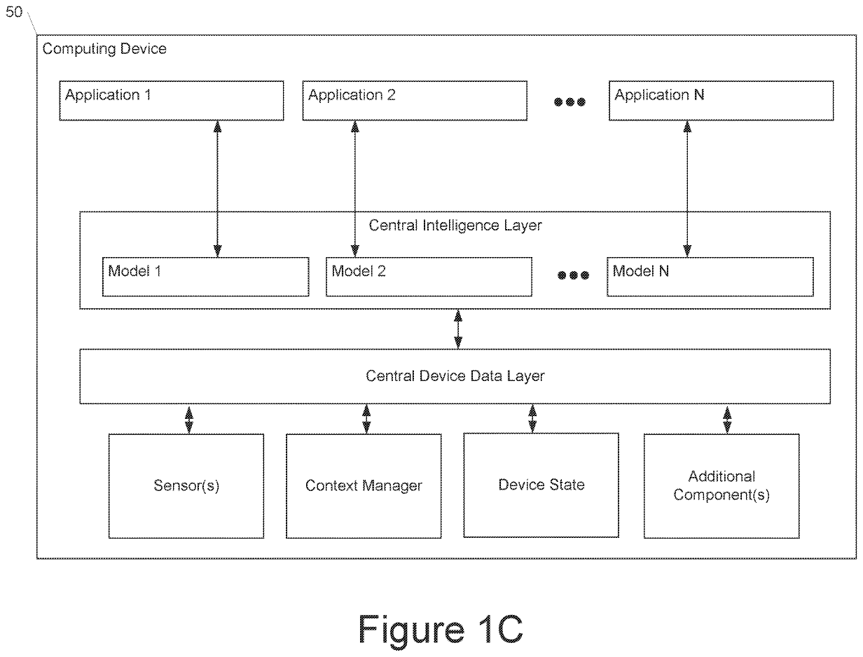

FIG. 1A depicts a block diagram of an example computing system 100 that performs text-driven color manipulation according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

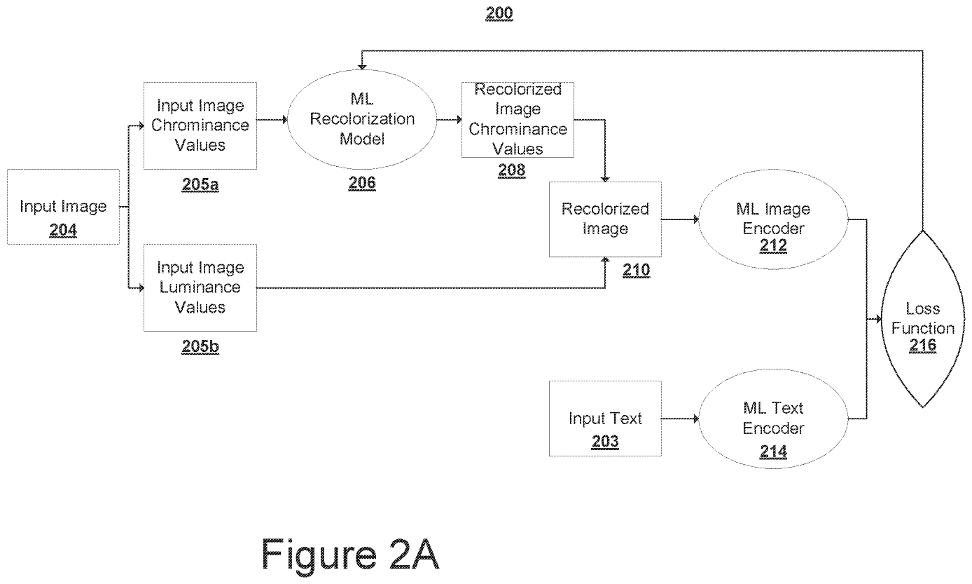

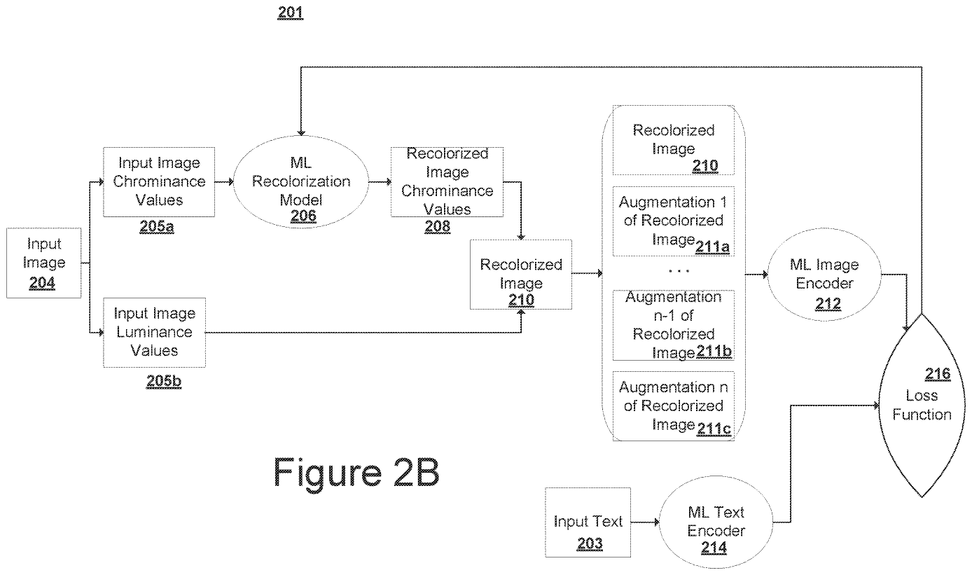

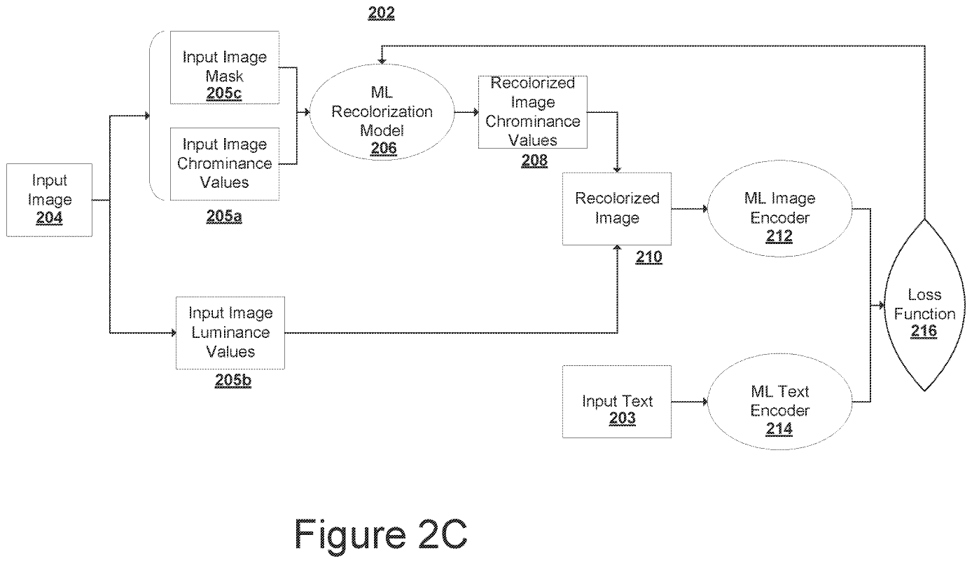

In some implementations, the user computing device 102 can store or include one or more models 120. For example, the models (e.g., recolorizing model) 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. In other examples, the models 120 can be specific image manipulation models which are differentiable and have been parameterized to facilitate application of machine learning techniques. Example models 120 are discussed with reference to FIGS. 2-4.

In some implementations, the one or more models 120 can be received from the server computing system 130 over network 180, stored in the user computing device memory 114, and then used or otherwise implemented by the one or more processors 112. In some implementations, the user computing device 102 can implement multiple parallel instances of a single model 120.

More particularly, the models 120 can be trained using a training computing system 150 with a set of user input data 162 to train the parameters of the model to optimize the model. Training data may also include the creation of low-resolution processed image data from high-resolution raw image data. Masks may also be used in training to provide a region of interest. In some instances, the mask can be inputted using a user input component 122 or automatically determined based on user input data 162.

Additionally or alternatively, one or more models 140 can be included in or otherwise stored and implemented by the server computing system 130 that communicates with the user computing device 102 according to a client-server relationship. For example, the OVERALL models 140 can be implemented by the server computing system 140 as a portion of a web service (e.g., an image manipulation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 2-4.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the models 120 and/or 140 based on a set of user input data 162. The user input data 162 can include, for example, an input image (e.g., the image to be manipulated), an input text (e.g., a description of the desired output image), and one or more masks to indicate the region of interest.

As disclosed herein, the user input data can be provided by the user computing device 102. Thus, in such implementations, the model 120 provided to the user computing device 102 can be trained by the training computing system 150 on user-specific data received from the user computing device 102.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2A depicts a flow diagram of an example technique 200 for manipulating the color of an image, according to example embodiments of the present disclosure. In some implementations, the computing system (e.g., user computing device 102, server computing device 130, training computing device 150, computing device 10, computing device 50) can process an original image to manipulate the color of the image according to the user-provided text using the example technique 200 described in FIG. 2A.

The example technique of 200 is trained to receive a set of input data, which can include an input text 203 and an input image 204. The input text 203 describes the way in which the input image 204 is to be manipulated by the technique 200. For example, a user can input, using the user input component 122, the input text 203 and select the input image 204. The input image 204 can have a plurality of channels comprising one or more chrominance channels and one or more luminance channels. The input text 203 may comprise a description of one or more desired properties of a recolorized image 210. For example, the input text 203 may comprise one or more desired colors of one or more elements of the recolorized image 210, e.g. “yellow sky with purple clouds”, “a man wearing a green T-shirt”, “a woman wearing a denim hat and pink blouse” or the like. Alternatively or additionally, the input text 203 may comprise a desired style of the recolorized image 210, e.g. “a pop art style building”. Alternatively or additionally, the input text 203 may comprise one or more desired conditions present in the recolorized image 210, e.g. “a photo of a landscape covered in snow”, “a photo of a landscape with an Aurora borealis” or the like.

The one or more values of the one or more chrominance channels 205a can be inputted into the machine-learned recolorizing model 206. The one or more values of the one or more luminance channels 205b can remain fixed (e.g., not be altered by the machine-learned recolorizing model 206). As a result of the receipt of the input chrominance values, the machine-learned recolorizing model 206 can provide recolorized image chrominance values 208 based on an initial set of one or more parameters. The recolorized image 210 can be generated by the combination of the recolorized image chrominance values 208 and the input image luminance values 205b. In some implementations, the machine-learned recolorizing model may be a multi-layer perceptron neural network.

Additionally, one or more parameters of the machine-learned recolorizing model 206 can be modified by back-propogation of the embedding loss between the input text 203 and the recolorized image 210. A machine-learned image encoder 212 can be used to generate one or more image embeddings from the recolorized image 210. Similarly, a machine-learned text encoder 214 can be used to generate a text embedding from the input text 203. A loss function 216 can then determine how well the input text 203 and the recolorized image 210 are now aligned by comparing the one or more image embeddings and the text embedding. In some implementations, the machine-learned image encoder 212 and the machine-learned text encoder 214 may utilize a pre-trained generator (e.g., CLIP-Contrastive Language-Image Pre-training: see, for example, arXiv: 2111.09888) which has been trained on a large dataset of images to convert text and image inputs into the same embedding space. For example, the loss function 216 can evaluate the sum of one or more distances between the text embedding and the one or more image embeddings.

Additionally, the one or more parameters of the machine-learned recolorizing model may then be adjusted to minimize that sum and then the image manipulation technique 200 may be repeated. Ultimately, the technique 200 will result in the optimization of the one or more parameters of the recolorizing model 206 such that the one or more image embeddings of the recolorized image are as close as possible to the text embedding.

In some implementations, as described by FIG. 2B, the image manipulation technique 201 may include augmentation of the input image. In some implementations, the computing system (user computing device 102, server computing device 130, training computing device 150, computing device 10, computing device 50) can process an input image to generate a recolorized image using the color manipulation technique described in FIG. 2B. The one or more augmented images 211a-c may be generated by augmenting the recolorized image 210. The one or more augmented images 211a-c may, for example, be generated by the cropping, flipping, warping, or rotation of the input image. The one or more augmented images 211a-c may then be used to generate one or more image embeddings using the machine-learned image encoder 212. The use of the one or more augmented images 211a-c allows for more accurate adjustment of the one or more parameters and therefore results in a more robust and accurate machine-learned recolorizing model 206.

In other implementations, as described by FIG. 2C, the technique 202 may include the use of masking. In some implementations, the computing system (user computing device 102, server computing device 130, training computing device 150, computing device 10, computing device 50) can process an input image to generate a recolorized image using the color manipulation technique described in FIG. 2C. In some implementations, the computing system can access an input image mask 205c in addition to the input image 204 and the input text 203. In some instances, the mask 205c can be determined by a machine-learned model 140 of the server computing system 130 (e.g., by using a segmentation model that determines the boundary of the object) or the mask can be obtained by the user input component 122 of the user computing device 102. For example, a user can input, using the user input component 122, the mask 205c having a region of interest associated with the input text. The mask 205c can be input into the machine-learned recolorizing model 206 in order to provide guidance for the regions which should be recolored. The use of masking in this technique increases the accuracy of the recolorized image 210 by preventing the recolorization of portions of the image not associated with the input text.

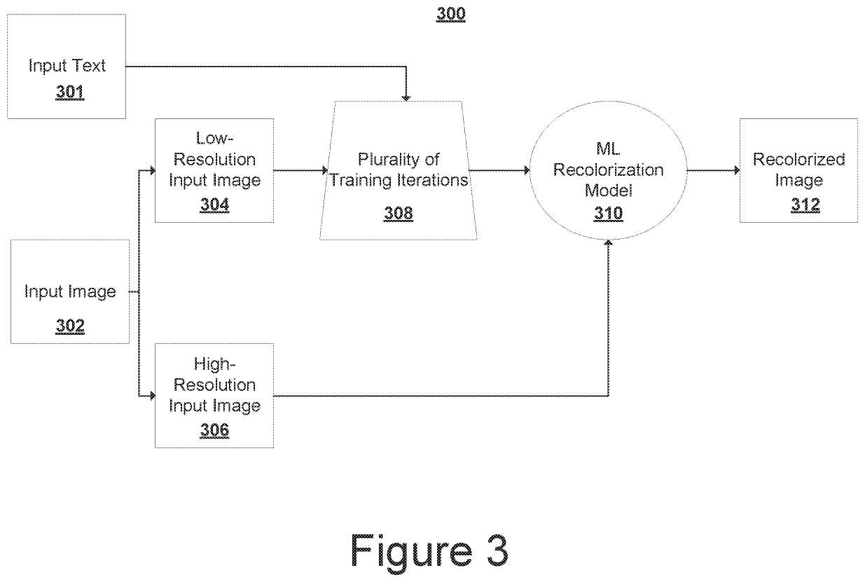

FIG. 3 depicts a flow diagram an example model 300 for manipulating the color of an image, according to example embodiments of the present disclosure. In some implementations, the computing system (e.g., user computing device 102, server computing device 130, training computing device 150, computing device 10, computing device 50) can process an original image to manipulate the color of the image according to the user-provided text using the example technique 300 described in FIG. 3.

The model of 300 is trained to receive a set of input data, which can include an input text 301 and an input image 302. The model 300 may include the generation of a low-resolution input image 304 and the maintaining of the resolution of the input image as a high-resolution input image 306. The low-resolution input image 304 may act as the input image 204 for a plurality of training iterations 308 using one or more of the techniques discussed in relation to FIGS. 2A-2C. The machine-learned recolorizing model 310 may be generated by the plurality of training iterations 308 with the low-resolution input image 034. Once the machine-learned recolorizing model 310 has been sufficiently trained, the high-resolution input image 306 may be used as an input image 204 for one or more of the techniques discussed in FIGS. 2A-2C in order to create a high-resolution recolorized image 312. Thus, the model 300 can generate a high-resolution, recolorized image using less processing time and power than would be required if the plurality of training iterations 208 were performed using the high-resolution input image 306 while still generating the same resolution of a recolorized image 312.

### Example Methods

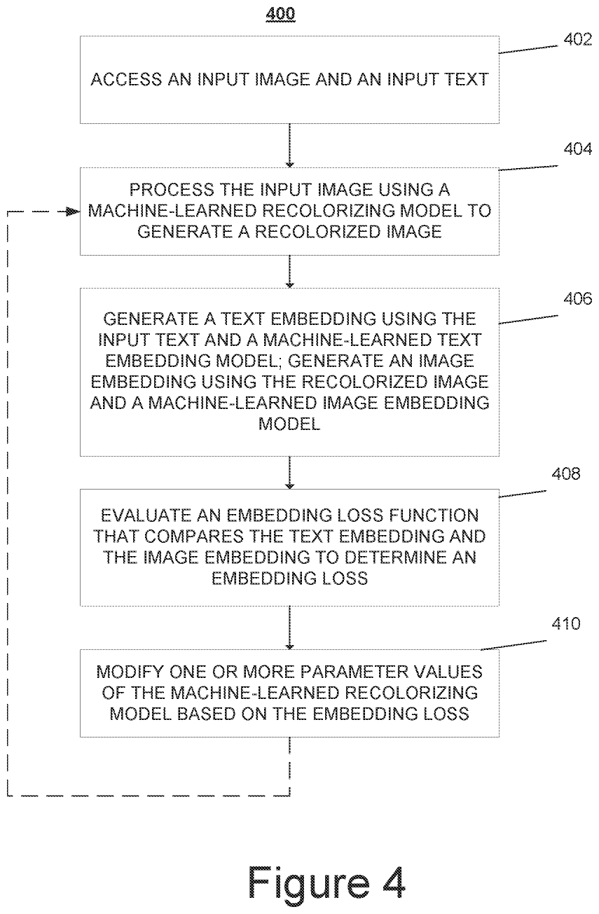

FIG. 4 depicts a flow chart diagram of an example for manipulating the color of an image according to an input text according to example embodiments of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

In some instances, the method 400 can include a computing system accessing an input image prior to step 402. For example, the computing system can process the input image in order to create a low-resolution version of the input image to serve as the input image for this method.

At 402, the computing system can access an input image and an input text. The computing system can be a computing device 102, server computing system 130, training computing system 150, computing device 10, computing device 50. The computing system can use one or more processors (e.g., processors(s) 112, 132, 152) to access the input image and input text at 402. In some implementations, the computing system may also access an input image mask at 402. The input image and input text may be input and/or selected by a user.

At 404, a computing system can process the input image using a machine-learned recolorizing model to generate a recolorized image. For example, the computing system, at step 404, can the machine-learned recolorizing model 206 described in FIGS. 2A-2C to generate the recolorized image 210.

At 406, the computing system can generate a text embedding using the input text and a machine-learned text embedding model as well as generate an image embedding using the recolorized image and a machine-learned image embedding model. For example, the computing system, at step 406, can use the machine-learned image encoder 212 and the machine-learned text encoder 214 to generate one or more image embeddings and a text embedding, respectively. In some implementations, the machine-learned image encoder 212 and the machine-learned text encoder 214 may utilize a pre-trained generator (e.g., CLIP) which has been trained on a large dataset of images to convert text and image inputs into the same embedding space.

For example, the computing system, at step 406, can generate one or more augmentations of the recolorized image, as described by FIG. 2B. The one or more image augmentations may then be used by the machine-learned image encoder 212 to generate one or more image embeddings 211a-c. The one or more augmented images 211a-c may, for example, be generated by the cropping, flipping, warping, or rotation of the input image.

At 408, the computing system can evaluate an embedding loss function that compares the text embedding and the image embedding to determine an embedding loss. In some implementations, the image embedding may include one or more image embeddings generated by the image encoder 212 using the one or more augmented images 211a-c. In some implementations, the embedding loss is the sum of one or more distances between the text embedding and the one or more image embeddings.

At 410, the computing system can modify one or more parameter values of the machine-learned recolorizing model based on the embedding loss. For example, the one or more parameters of the machine-learned recolonizing model may be modified based on a back-propogation of the embedding loss, determined at 408, to the machine-learned recolorization model 206. The machine-learned recolorizing model with updated parameters is then used at the next iteration of operations 404 to 410.

Operations 404 to 410 may be iterated until one or more threshold conditions are satisfied. The threshold condition may, for example, be a threshold number of iterations. Alternatively or additionally, the one or more threshold conditions may comprise the embedding loss function for an iteration falling below a threshold value.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for recolorizing an image, the method comprising:
accessing, by one or more computing devices, an input image and an input text; and
for each of a plurality of training iterations:
processing, using a machine-learned recolorizing model, the input image to generate a recolorized image;
generating a text embedding using the input text and a machine-learned text embedding model;
generating one or more image embeddings using the recolorized image and a machine-learned image embedding model;
evaluating an embedding loss function that compares the text embedding and the image embedding to obtain an embedding loss; and
modifying one or more parameter values of the machine-learned recolorizing model based on the embedding loss; and
after the plurality of iterations, providing the recolorized image as an output image.

2. The computer-implemented method of claim 1, wherein the input image has a plurality of channels comprising one or more chrominance channels and one or more luminance channels, and wherein the machine-learned recolorizing model modifies one or more values in the one or more chrominance channels while holding the one or more luminance channels fixed.

3. The computer-implemented method of claim 1, wherein generating one or more image embeddings includes:
augmenting the recolorized image to generate one or more augmented images; and
generating one or more image embeddings using the augmented images and a machine-learned image embedding model.

4. The computer-implemented method of claim 3, wherein the embedding loss function evaluates the sum of one or more distances between the text embedding and the one or more image embeddings.

5. The computer-implemented method of claim 1, wherein processing the input image includes:
processing the input image and a mask to generate a masked image, wherein the mask indicates a region of interest associated with the input image, and the masked image is inputted into the machine-learned recolorizing model to generate the recolorized image.

6. The computer-implemented method of claim 1, wherein the input image used in the plurality of training iterations is a low-resolution image, and the output image is a high-resolution image.

7. The computer-implemented method of claim 1, wherein the machine-learned recolorizing model comprises a multi-layer perceptron neural network.

8. The computer-implemented method of claim 1, wherein one or more parameters of the machine-learned recolorizing model are modified based on a back-propagation of the embedding loss through the machine-learned image embedding model.

9. A computing system, comprising:
one or more processors; and
one or more non-transitory computer-readable media that collectively store:
a machine-learned recolorizing model, wherein the machine-learned recolorizing model is configured to generate a recolorized image using an input image and an input text; and
instructions that, when executed by the one or more processors, cause the computing system to perform operations, the operations comprising:
for a plurality of training iterations:
accessing the input image and the input text;
processing, using the machine-learned recolorizing model, the input image to generate the recolorized image;
generating a text embedding using the input text and a machine-learned text embedding model;
generating one or more image embeddings using the recolorized image and a machine-learned image embedding model;
evaluating an embedding loss function that compares the text embedding and the image embedding and determines an embedding loss; and
modifying one or more parameter values of the machine-learned recolorizing model based on the embedding loss; and
after the plurality of iterations, providing the recolorized image as an output image.

10. The computer system of claim 9, wherein the input image has a plurality of channels comprising one or more chrominance channels and one or more luminance channels, and wherein the machine-learned recolorizing model modifies one or more values in the one or more chrominance channels while holding the one or more luminance channels fixed.

11. The computer system of claim 9, wherein generating the one or more image embeddings comprises:
augmenting the recolorized image to generate one or more augmented images; and
generating one or more image embeddings using the augmented images and a machine-learned image embedding model.

12. The computer system of claim 9, wherein the embedding loss function evaluates the a sum of one or more distances between the text embedding and the one or more image embeddings.

13. The computer system of claim 9, wherein processing the input image further comprises:
processing the input image and a mask to generate a masked image, wherein the mask indicates a region of interest associated with the input image, and the masked image is inputted into the machine-learned recolorizing model to generate the recolorized image.

14. The computer system of claim 9, wherein the input image used in the plurality of training iterations is a low-resolution image, and the output image is a high-resolution image.

15. The computer system of claim 9, wherein the machine-learned recolorizing model comprises a multi-layer perceptron neural network.

16. The computer system of claim 9, wherein one or more parameters of the machine-learned recolorizing model are modified based on a back-propogation of the embedding loss via the machine-learned image embedding model.

17. A non-transitory computer-readable memory having instructions stored thereon which, when executed by a system comprising a processor, are configured to cause the system to:
access an input image and an input text; and
for each of a plurality of training iterations:
process, using a machine-learned recolorizing model, the input image to generate a recolorized image;
generate a text embedding using the input text and a machine-learned text embedding model;
generate one or more image embeddings using the recolorized image and a machine-learned image embedding model;
evaluate an embedding loss function that compares the text embedding and the image embedding to determine the embedding loss; and
modify one or more parameter values of the machine-learned recolorizing model based on the embedding loss; and
after the plurality of iterations, provide the recolorized image as an output image.

18. The non-transitory computer-readable memory of claim 17,
wherein processing the input image using the machine-learned recolorizing model includes processing the input image and a mask to generate a masked image; and
wherein the mask indicates a region of interest associated with the input image, and the masked image is inputted into the machine-learned recolorizing model to generate the recolorized image.

19. The memory of claim 17, wherein the input image has a plurality of channels comprising one or more chrominance channels and one or more luminance channels, and wherein the machine-learned recolorizing model modifies one or more values in the one or more chrominance channels while holding the one or more luminance channels fixed.

20. The memory of claim 17, wherein the input image has a plurality of channels comprising one or more chrominance channels and one or more luminance channels, and wherein the machine-learned recolorizing model modifies at least one of one or more values in the one or more chrominance channels or one or more values in the one or more luminance channels.
